(19) United States
(12) Patent Application Publication
(10) Pub. No.: US 2012/0185708 A1
(43) Pub. Date: Jul. 19, 2012

(54) POWER SUPPLY DEVICE, POWER RECEIVING DEVICE, AND POWER SUPPLY METHOD

(75) Inventors: Junichi Rekimoto, Kanagawa (JP); Shigeru Tajima, Kanagawa (JP)

(73) Assignee: Sony Corporation, Tokyo (JP)

(21) Appl. No.: 13/496,792

(22) PCT Filed: Oct. 13, 2010
(86) PCT No.: PCT/JP2010/006089

§ 371 Date: Mar. 16, 2012

(30) Foreign Application Priority Data
Oct. 23, 2009 (JP) 2009-244424

(51) Int. Cl. G06F 1/26; H04W 52/04

(52) U.S. Cl. 713/310

(57) ABSTRACT

A power sever, client and method cooperate to selectably supply power from a power server to a client in a format that is acceptable to the client. The client device is able to distinguish the power server from other power servers based on an identification of the power server transmitted to the client device. The client device is then able to specify, or select, from the specific power server the format of the energy to be conveyed to the client device for ultimate consumption by the client device. The conveyance of energy is provided over conductors or wirelessly.

### TECHNICAL FIELD

The present invention relates to a power supply device, a power receiving device, and a power supply method.

### BACKGROUND ART

Many electronic devices such as personal computers and game machines use an AC adaptor, which inputs an alternating-current (AC) power from a commercial power supply and outputs electric power in a format compatible with the device, for the purpose of operating the device and charging the battery. Although the electronic device is usually operated by a direct current (DC), the voltage and current are different in each device. Thus, the AC adaptor outputting electric power matching each device is also different for each device. Thus, even if AC adaptors have similar shapes, they can be incompatible with each other, and there is an issue that the number of AC adaptors increases with increasing numbers of devices.

In order to solve the above issue, there has been proposed a power bus system in which a power supply block supplying electric power to devices such as a battery and an AC adaptor and a power consumption block receiving electric power from the power supply block are connected to a common DC bus line (for example, Patent Literatures 1 and 2, listed below). In this power bus system, a DC current flows through a bus line. Further, in the power bus system, each block itself is described as an object, and the objects of the respective blocks mutually transmit and receive information (state data) through a bus line. The object of each block generates the information (state data) based on a request from the object of another block and transmits the information as reply data. The object of the block having received the reply data can control electric power supply and consumption based on the contents of the received reply data.

### CITATION LIST

### Patent Literature

PTL 1: Japanese Patent Application Laid-Open No. 2001-306191

PTL 2: Japanese Patent Application Laid-Open No. 2008-123051

### SUMMARY OF INVENTION

### Technical Problem

In the power bus systems disclosed in the Patent Literature references 1 and 2, for example, all communications between a server and a client are performed through a bus line. Meanwhile, as a mechanism for feeding electric power, there is wireless power transfer using a magnetic line and the like, and when the power feeding mechanism such as wireless power transfer is incorporated in the power bus system, it is inappropriate to support wire-based communication. The present inventors recognized that this conventional approach does not allow for client devices to distinguish between different power servers that may be able to provide different power formats for conveying power to the client devices wirelessly or directly.

### BRIEF DESCRIPTION OF DRAWINGS

FIG. 1 is an explanatory view showing a constitution of a power supply system according to a first embodiment.

FIG. 2 is an explanatory view for explaining a power supply processing by a power supply system 1 according to the first embodiment.

FIG. 3 is an explanatory view showing a constitution of a power supply server 100 according to the first embodiment.

FIG. 4A is an explanatory view showing a change of a voltage observed on a bus line 10.

FIG. 4B is an explanatory view showing a change of a voltage observed on a bus line 10.

FIG. 5 is a flow chart showing a voltage detection processing in a server and a client, having received a synchronous packet, in the power supply system 1 according to the first embodiment.

FIG. 6 is an explanatory view showing a power supply system 2 according to a second embodiment.

FIG. 7 is a flow chart of a method for communicating between a power server and client, prior to the power server conveying power to the client for use in powering the client.

### DESCRIPTION OF EMBODIMENTS

Hereinafter, exemplary embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Descriptions will be made in the following order:

<1. First embodiment>

(1-1. Constitution of power supply system)

(1-2. Power supply processing by power supply system)

(1-3. Constitution example of power supply server)

(1-4. Operation example of power supply server)

<2. Second embodiment>

(2-1. Constitution of power supply system)

(2-2. Operation of power supply system)

<3. Conclusion>

### 1. First Embodiment

### 1-1. Constitution of Power Supply System

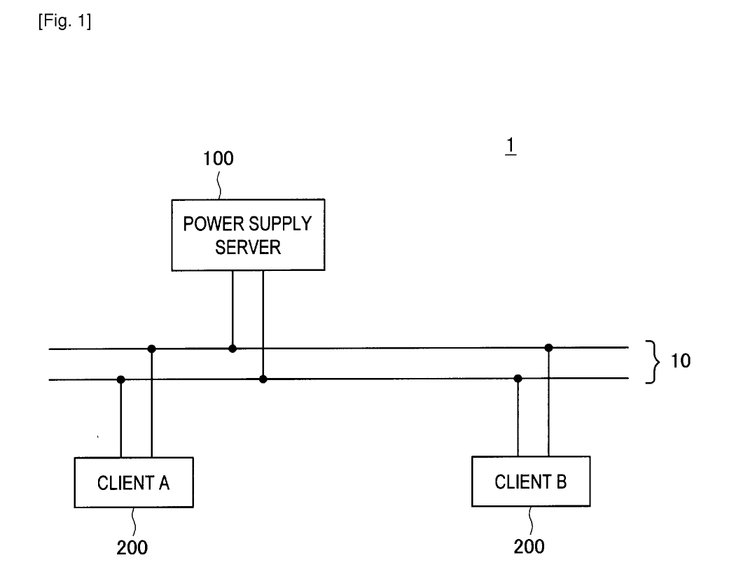

First, a constitution of a power supply system according to a first embodiment of the present invention will be described. FIG. 1 is an explanatory view showing the constitution of the power supply system according to the first embodiment. Hereinafter, the constitution of the power supply system according to the first embodiment will be described using FIG. 1.

As shown in FIG. 1, a power supply system 1 is configured to include a power supply server 100 and a client 200. The power supply server 100 and the client 200 are connected to each other through a bus line 10, which, as shown, may include separate conductors.

The power supply server 100 supplies DC power to the client 200. The power supply server 100 further transmits and receives an information signal to and from the client 200. In the present embodiment, the DC power supply and the transmission and reception of the information signal between the power supply server 100 and the client 200 are shared on the bus line 10.

The power supply server 100 is configured to include a communication modem for use in transmitting and receiving the information signal and a microprocessor for use in controlling an electric power supply, and a switch controlling a DC power output. However, the processor may also be a logic-based device such as an application specific integrated circuit (ASIC) or a programmable logic array (PLA).

The client 200 receives the DC power supply from the power supply server 100. The client 200 further transmits and receives the information signal to and from the power supply server 100. In FIG. 1, the two clients 200 are illustrated. In the following description, for convenience's sake of explanation, the two clients 200 are distinguished respectively as CL1 or CL2.

The client 200 is configured to include a communication modem for use in transmitting and receiving the information signal and a microprocessor for use in controlling the electric power supply, and a switch controlling the DC power output.

In the power supply system 1 shown in FIG. 1, the single power supply server 100 and the two clients 200 are illustrated. However, in the present invention, the number of the power supply servers and the number of the clients are not limited to the specific numbers shown in the example.

Since a method of supplying electric power in the power supply systems 1 and 2 shown in FIG. 1 is described in Japanese Patent Application Laid-Open No. 2008-123051, the entire contents each of Japanese Patent Application Laid-Open No. 2008-123051 is incorporated herein by reference. However, hereinafter, processing performed by the power supply system 1 according to the present embodiment will be briefly described.

### 1-2. Power Supply Processing By Power Supply System

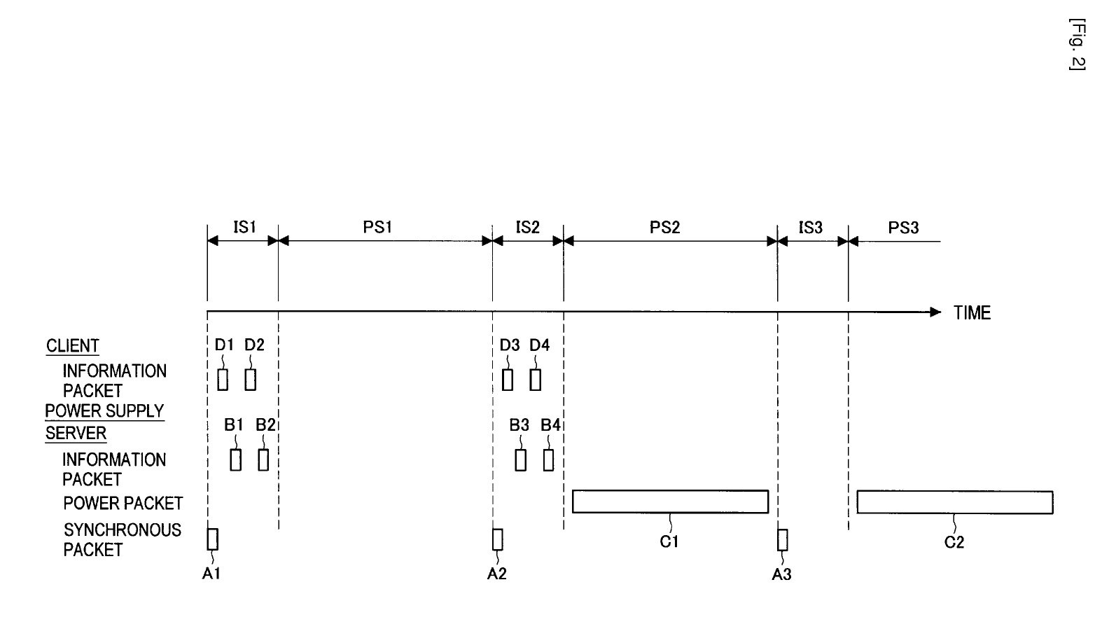

FIG. 2 is an explanatory view for explaining the power supply processing by the power supply system 1 according to the present embodiment. Hereinafter, the power supply processing by the power supply system 1 according to each of the above embodiments of the present invention will be described using FIG. 2.

As shown in FIG. 2, the power supply server 100 periodically outputs synchronous packets A1, A2, A3, and . . . to the bus line 10. The power supply server 100 further outputs information packets B1, B2, B3, and . . . and power packets C1, C2, C3, and . . . so as to supply electric power to the client 200. The information packets B1, B2, B3, and . . . are the information signals transmitted and received to and from the client 200, and the power packets C1, C2, C3, and . . . are obtained by packetizing an electric power energy. Meanwhile, the client 200 outputs information packets D1, D2, D3, and . . . that are the information signals transmitted and received to and from the power supply server 100 so as to receive electric power supply from the power supply server 100.

The power supply server 100 outputs the synchronous packets A1, A2, A3, and . . . at the start of a time slot of a predetermined interval (for example, every 1 second). The time slot includes an information slot through which the information packet is transmitted and a power slot through which the power packet is transmitted. Information slots IS1, IS2, IS3, and . . . are sections where the information packets are exchanged between the power supply server 100 and the client 200. Power supply slots PS1, PS2, PS3, and . . . are sections where the power packets C1, C2, C3, and . . . supplied from the power supply server 100 to the client 200 are output. The information packet is a packet capable of performing output only in the sections of the information slots IS1, IS2, IS3, and . . . . Thus, when the transmission and reception of the information packet is not completed in one information slot, the information packet is transmitted over a plurality of information slots. Meanwhile, the power packet is a packet capable of performing output only in the sections of the power supply slots PS1, PS2, PS3, and . . . .

The power supply server 100 has one or two or more server power supply profiles showing a power specification that can be supplied by itself. Exemplary power specifications may include parameters of voltage range, amperage, duty cycles, AC frequency or DC. The client 200 receives the electric power supply from the power supply server 100 which can supply electric power matching to its own specification. At this time, the client 200 obtains a server power supply profile from the power supply server 100 and determines the specification (server power supply profile) of the power supply server 100 for the client 200 itself. Specifically, the client 200 first detects a synchronous packet A1 to be output to the power supply server 100 and obtains the address of the power supply server 100 included in the synchronous packet A1. The address may be a MAC address, for example. Next, the client 200 transmits to the power supply server 100 an information packet D1 that requests transmission of the number of the server power supply profiles possessed by the power supply server 100.

The power supply server 100 having received the information packet D1 transmits a server power supply profile number in the information packet B1. The server power supply profile number is the number of the server power supply profiles of the power supply server 100. The client 200 having received the information packet B1 obtains from the power supply server 100 the contents of the server power supply profile with the number equal to the number of the server power supply profiles of the power supply server 100. For example when the power supply server 100 has two server power supply profiles, the client 200 first obtains one of the two server power supply profiles. The client 200 having received one of the two server power supply profiles transmits to the power supply server 100 the server power supply profile as the information packet D2 requesting the use of the power supply.

The power supply server 100 having received the information packet D2 transmits a first server power supply profile as the information packet B2 to the client 200. The first server power supply profile is stored in a storage part (not shown) included in the power supply server 100. The client 200 having received the information packet B2 from the power supply server 100 transmits the information packet for use in obtaining a second server power supply profile. However, the information slot IS1 terminates at this point, and the power supply slot PS1 for use in transmitting the power supply packet starts. Thus, this information packet is transmitted in the next information slot IS2. In the power supply slot PS1, since the power specification that the client 200 receives electric power from the power supply server 100 is not determined, and the electric power supply is not performed.

The power slot PS1 terminates, and the synchronous packet A2 showing the start of the next time slot is output from the power supply server 100. Thereafter, the client 200 having received the information packet B2 from the power supply server 100 transmits the information for use in obtaining the second server power supply profile as the information packet D3.

The power supply server 100 having received the information packet D3 transmits the second server power supply profile as the information packet B3 to the client 200. The second server power supply profile is stored in a storage part (e.g., a memory such as a semiconductor memory, not shown) included in the power supply server 100. The client 200 having received the information packet B3 to obtain the two server power supply profiles of the power supply server 100 selects the server power supply profile with a power specification matching to the client 200 itself. The client 200 then transmits to the power supply server 100 the information packet D4 for use in determining the selected server power supply profile.

The power supply server 100 having received the information packet D4 transmits information, which serves as the information packet B4 and represents such a response that the power specification is determined, to the client 200 so as to notify the completion of the determination of the first server power supply profile to the client 200. Thereafter, when the information slot IS2 terminates and the power slot PS2 starts, the power supply server 100 outputs the power supply packet C1 to the client 200 and performs power supply. With regard to the timing of transmission of the power packet, a power supply start time can be designated by the client 200 to the power supply server 100 by using the information representing a transmission start time setting request.

Hereinbefore, the power supply processing by the power supply system 1 according to the above-described embodiments has been described.

As described above, in the power supply system 1, there is a synchronous server integrating the entire system. The synchronous server starts to output the synchronous packet to the bus line, and other server and client detecting the synchronous packet are registered as a member of the system. Then, the client and the server negotiate on the specification of the supplied power through the bus line. Hereinafter, the transmission of packets from the synchronous server and the execution of the negotiation between the client and the server by wireless communication will be described.

In the system disclosed in the Patent Literature 2, for example, since a signal and electric power flow on the same bus line, the client and the server receive the synchronous packet from the synchronous server to thereby automatically understand that the synchronous packet is on a certain system. Moreover, there is no recognition of multiple power servers, and therefore a client could not discriminate between power servers if multiple power servers were present. Meanwhile, when the communication path is wireless, even if the client and the server receive the synchronous packet, it is not sure if the synchronous packet is transmitted from the synchronous server connected to the same power system supplying electric power.

Thus, in the present embodiment, a method of detecting that each device is on the same power supply line using wireless communication will be described. The present is based on the electric power being supplied through a wire. First, a constitution example of the power supply server according to the first embodiment of the present invention will be described.

### 1-3. Constitution Example of Power Supply Server

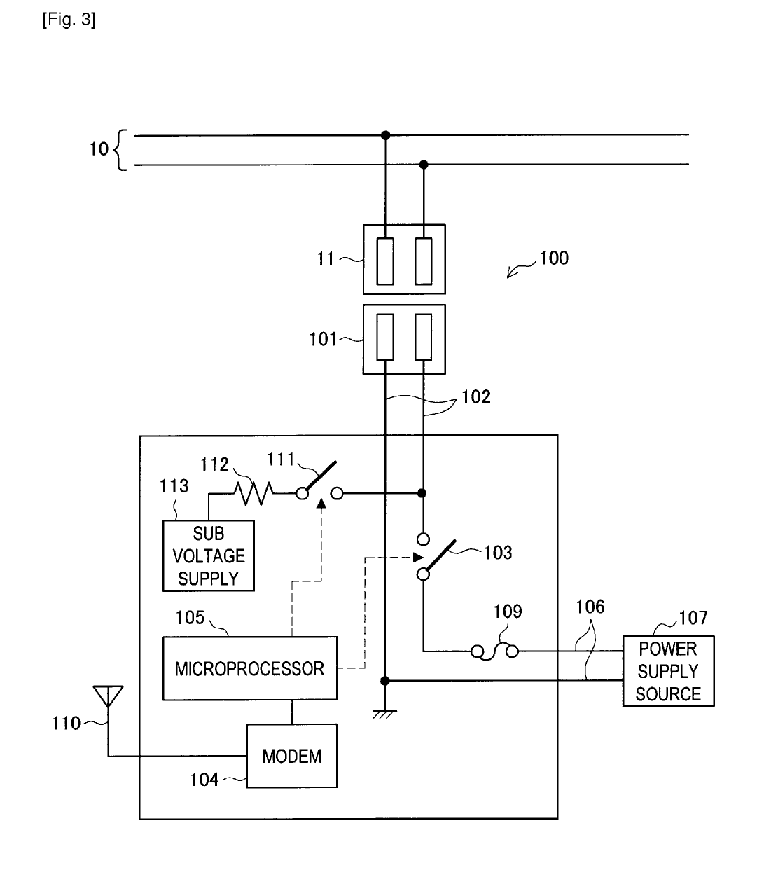

FIG. 3 is an explanatory view showing a constitution of the power supply server 100 according to the first embodiment. Hereinafter, the constitution of the power supply server 100 according to the first embodiment will be described using FIG. 3.

As shown in FIG. 3, the power supply server 100 according to the first embodiment is configured to include a connector 101, connecting wires 102 and 106, a main switch 103, a modem 104, a microprocessor 105, a power supply source 107, a fuse 109, an antenna 110, a sub switch 111, a resistor 112, and a sub voltage supply 113. A subset or all of connection 101, wires 102 and 106, and antenna 110 may be a part of an electrical interface.

The connector 101 connects a power supply server body and the bus line 10 (an example of a common medium) by connecting to the connector 11. The connecting wire 102 is used for connecting the connector 101 and the power supply server body. The main switch 103 controls an electric power output. When the main switch 103 is turned on, the power supply server 100 can convey electric power from the power supply source 107 to the bus line 10, which may be used to provide operational power to the client. By the way, the operational power needed not be used immediately by the client, but may be stored at the client and used at a later time. Meanwhile, when the main switch 103 is turned off, the power supply server 100 can stop the electric power supply from the power supply source 107.

The modem 104 is used for transmitting and receiving information to and from other power supply server and client via the common medium, which in this case is the bus line 10. While the modem 104 transmits a communication signal to the antenna 110, the modem 104 receives the communication signal wirelessly received by the antenna 110.

The microprocessor 105 controls the operation of the power supply server 100. When negotiation between the power supply server 100 and the client (for example, the client 200 of FIG. 1) is completed, the microprocessor 105 turns on the main switch 103 so that electric power is supplied from the power supply source 107, whereby the electric power can be supplied to the bus line 10.

The connecting wire 106 is used for connecting the power supply server body and the power supply source 107. The power supply source 107 can supply electric power including DC voltage. When the main switch 103 of the power supply server 100 is turned on, DC power can be supplied to the bus line 10. The fuse 109 is used for protecting circuits from high current. If a current higher than a rated current flows, the fuse 109 cuts itself by its own generated heat to prevent flow of high current.

The antenna 110 transmits and receives a signal wirelessly. The antenna 110 receives signals wirelessly transmitted from another server (the synchronous server or the power supply server) and client and wirelessly transmits signals to other server and client. When the antenna 110 wirelessly receives a signal from the other server and client, the signal is transmitted to the modem 104 to be subjected to demodulation processing in the modem 104. The signal subjected to the modulation processing in the modem 104 is wirelessly transmitted from the antenna 110 to arrive at other server and client.

The sub switch 111 switches connection between the connecting wire 102 and the resistor 112 and is constituted so as to be switched on and off by control of the micro-processor 105. The resistor 112 and the sub voltage supply 113 are used for supplying a predetermined DC voltage V from the sub voltage supply 113 to the bus line 10 by the connection of the sub switch 111. The predetermined voltage V may be fixed or varied. The resistor 112 is provided so as to prevent devices in the power supply server 100 from being broken by a short circuit occurring in the power supply server 100.

Hereinbefore, the constitution of the power supply server 100 according to the first embodiment of the present invention has been described using FIG. 3. Next, the operation of the power supply server 100 according to the first embodiment will be described. In the following description, the operation of the power supply server 100 in the case where the power supply server 100 is also operated as a synchronous server will be described.

### 1-4. Operation Example of Power Supply Server)

In the power supply system 1, when negotiation between the client and the server is completed, and the client knows which server it is communicating with and has set the specification for the power to be supplied, the power supply server starts electric power supply, and the client is in a state capable of receiving the electric power supply. Moreover, in the negotiation, information of a unique ID for use in uniquely specifying the power supply system may be shared between the server and the client. When the power supply server 100 is operated as the synchronous server, the microprocessor 105 wirelessly transmits a synchronous packet (message content) through the modem 104 and the antenna 110. The microprocessor 105 then turns on the sub switch 111 for an appropriate time (for example, a guard time between power packets defined by the power supply system 1). The sub switch 111 is connected to the sub voltage supply 113 outputting a predetermined voltage V through a specified impedance (the resistor 112). Thus, during the above time, the predetermined voltage V from the sub voltage supply 113 appears on the bus line 10.

Thus, the connection to the power supply system 1 can be determined by whether or not the voltage V from the sub voltage supply 113 can be detected at the timing of wirelessly receiving the synchronous packet. The value of the voltage V is broadcasted as a parameter of the synchronous packet wirelessly transmitted from the antenna 110. Further, the value of the voltage V may be changed at each timing of transmitting the synchronous packet.

By virtue of the appearance of the voltage V from the sub voltage supply 113 on the bus line 10, even if there are a plurality of wireless synchronous packets, each server and client connected to the bus line 10 can specify a power transmission and distribution system to which the server and client are connected or whether they are not connected thereto. The synchronous packet transmitted from the power supply server 100, operated as the synchronous server, is transmitted including the unique ID of the power supply system 1 to which the power supply server 100 belongs. Thus, each server and client having received the synchronous packet from the power supply server 100 can uniquely specify the power transmission and distribution system.

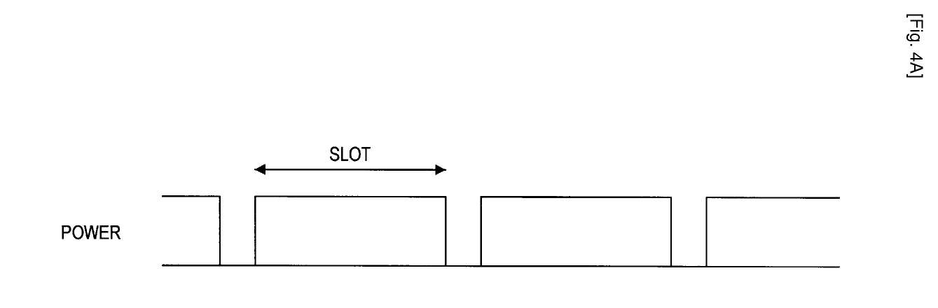

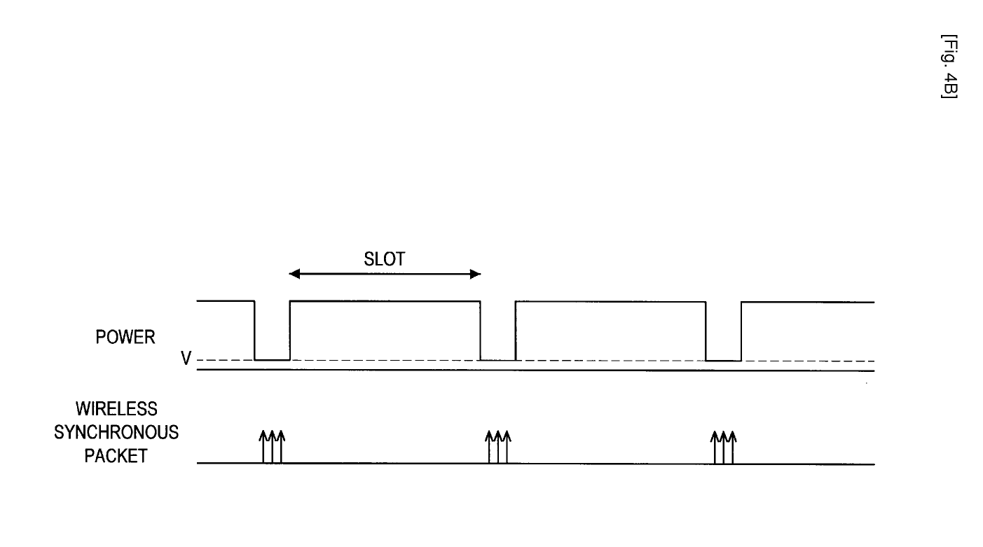

FIG. 4A is an explanatory view showing a change of a voltage observed on the bus line 10. FIG. 4A shows a change of a voltage on a bus line in the power supply system (in related art) free from the voltage V from the sub voltage supply 113. As shown in FIG. 4A, in the system disclosed in the Patent Literature 2, for example, a no-voltage section (a guard section) free from voltage exists between slots to which electric power from the power supply server is supplied.

FIG. 4B is an explanatory view showing a change of a voltage observed on the bus line 10. FIG. 4B shows a change of a voltage observed on the bus line 10 in the power supply system 1 according to the first embodiment. FIG. 4B also shows the synchronous packet wirelessly transmitted from the synchronous server (the power supply server 100) on the same time axis. As shown in FIG. 4B, in the power supply system 1 according to the first embodiment, the predetermined voltage V supplied from the synchronous server (the power supply server 100) is observed in the guard section. The synchronous packet wirelessly transmitted from the synchronous server (the power supply server 100) includes the information of the voltage V and the unique ID of the power supply system 1. Thus, when the voltage value of the voltage V appearing on the bus line and the information of the voltage value included in the synchronous packet received at the timing when the voltage V appears on the bus line coincide with each other, the server and the client connected to the bus line on which the voltage shown in FIG. 4B is observed can specify the power transmission and distribution system to which they belong.

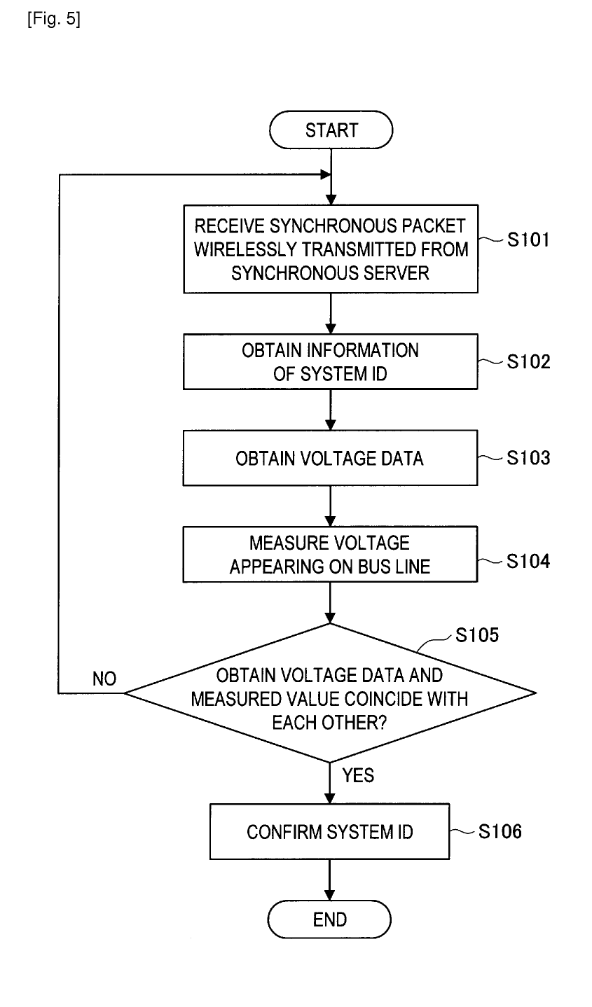

FIG. 5 is a flow chart showing a voltage detection processing in the server and the client having received the synchronous packet in the power supply system 1 according to the first embodiment. Hereinafter, the voltage detection processing in the server and the client having received the synchronous packet will be described using FIG. 5. In the following description, the server and the client wirelessly receiving the content from synchronous server are simply referred to as a “device”.

The device under the power supply system 1 first receives the synchronous packet (e.g., message content) wirelessly transmitted from the synchronous server (step S101). The device having received the synchronous packet demodulates the synchronous packet by the modem to decode the synchronous packet by the microprocessor, and, thus, to obtain information of a system ID (step S102) and, at the same time, obtain voltage data included in the synchronous packet (step S103).

Then, the device measures the voltage appearing on the bus line 10 at the timing of receiving the synchronous packet (step S104) to determine whether or not the measured result and the voltage data obtained in step S103 coincide with each other (step S105). As the result of the determination in step S105, if the measured result does not coincide with the voltage data obtained in step S103, the flow returns to step S101, and the device receives the synchronous packet wirelessly transmitted from the synchronous server. Meanwhile, as the result of the determination in step S105, when the measured result coincides with the voltage data obtained in step S103, the device confirms the ID of the power supply system obtained in step S102 (step S106).

In the system disclosed in the Patent Literature 2 and the like, the power supply system does not have the ID for use in uniquely specifying the system. This is because, in the example of related art, information and electric power flow on the same bus line through a wire, and since only one power supply system exists on one bus line in principle, no information of uniquely specifying the system is necessary. Meanwhile, in the present embodiment, since the synchronous packet is wirelessly transmitted, the server and the client having received the synchronous packet specify that the synchronous packet has been transmitted from a particular one of the synchronous servers.

Thus, in the present embodiment, an appropriate DC voltage output from the synchronous server (the power supply server 100) has a certain impedance (the resistor 112) to be output to the bus line 10 for a guard section. The server and the client detecting the DC voltage perform determination of the voltage having a high input impedance and existing on the bus line 10.

The voltage on the bus line 10 is monitored simultaneously by a plurality of devices, and the total impedance of the devices may cause slight reduction in voltage. Also in this case, since a voltage of a detected voltage pulse is described in the synchronous packet transmitted from the synchronous server, the voltage value can be easily determined from the transition of the voltage value described in the synchronous packet. In another server and client, by virtue of the provision of a voltage detector that detects the voltage level appearing on the bus line 10 in the guard section, even if the communication system is completely wireless, it is possible to determine whether each power supply server and client are connected to one power transmission and distribution system or whether they are not connected thereto.

The above method enables each device to specify a group of a wired power connection using a wireless connection to allow the use of the method disclosed in the Patent Literature 2 and the like, such as the determination of the synchronous server, the specification of the power supply server and a power supply client existing on the system, the negotiation between the server and the client, and the transmission and reception of electric power.

In the above description, in order to know that the server and the client exist on the same wired bus line, there has been shown the method in which the synchronous server sends an appropriate DC voltage for the guard section between power slots, and the DC voltage is detected in other servers and clients. In the following method, the output of the DC voltage in the guard period of time is not performed, only the ID uniquely distinguishing the power supply system is used, and the ID is transmitted and received in a wireless communication link.

In the above method, an ID is provided in the power supply system, and a system to which the ID is broadcasted as a parameter by wireless transmission is assumed. The parameter is appropriately a parameter of a synchronous packet, and the server and the client receiving the synchronous packet can recognize the ID of the power bus system to which the server and the client belong. The ID may be set long enough so as to be uniquely identifiable over the world or may be set shorter, but still sufficiently large enough to prevent overlap in a particular vicinity.

In the server and the client connected to the electric supply system having the ID, a human (for example, an administrator of the system) previously sets the ID in the construction of the system. Namely, when the power supply system having a plurality of wireless signal links exists, the system to which the server and the client will be connected is set manually. According to this constitution, even if actual electric power transfer is not performed between the server and the client, when the systems have the same ID, they can be confirmed as belonging to the same system.

Thus, unlike with the system described in the Patent Literature 2, the ID of the power supply system is provided as a parameter in the wirelessly transmitted synchronous packet, and the ID can be set manually.

In the power supply system using the method of wirelessly transmitting and receiving only ID, if a setting error of ID occurs for the server and client, the electric power transfer may not be impossible to be performed between the server and the client. In the server or client for which the setting error of ID occurs, it is determined that there is no system in a protocol shown in the power supply system disclosed in the Patent Literature 2 and the like, whereby the relevant server or client is automatically separated from the system. Thus, in this case, the relevant server or client displays that “it is not connected to the system” to notify to a user, whereby the user can know the trouble.

### 2. Second Embodiment of the Present Invention

In the above description, there has been described the power supply system in which, although electric power is supplied through a wire, information is transmitted and received wirelessly. Next, there will be described a power supply system in which both the electric power supply and the transmission and reception of information are performed wirelessly. The following description assumes that the ID of the power supply system is set manually, although other automated methods of setting the ID may be used.

Since a power transfer line is not a bus line but a space (e.g., an air gap or other propagation medium), transferable electric power is not DC but AC. Nevertheless, this space is a type of medium for conveying information and electromagnetic energy. In the present embodiment, the form in which the energy is conveyed is not limited, and so the form of electric energy may be AC, which may be used to excite an antenna and produce or receive electromagnetic energy (which includes electric or magnetic energy). However, even if electric power is DC, mere existence of one bus line and another bus line through which one wants to transmit and receive electric power makes a difference in construction of a mechanism of efficient power transfer between the bus lines. Thus, in the present embodiment, there will be described a case where the electric power supply and the transmission and reception of information can be performed wirelessly using a power coupler (a type of interface) in the exchange of electric power.

### 2-1. Constitution of Power Supply System

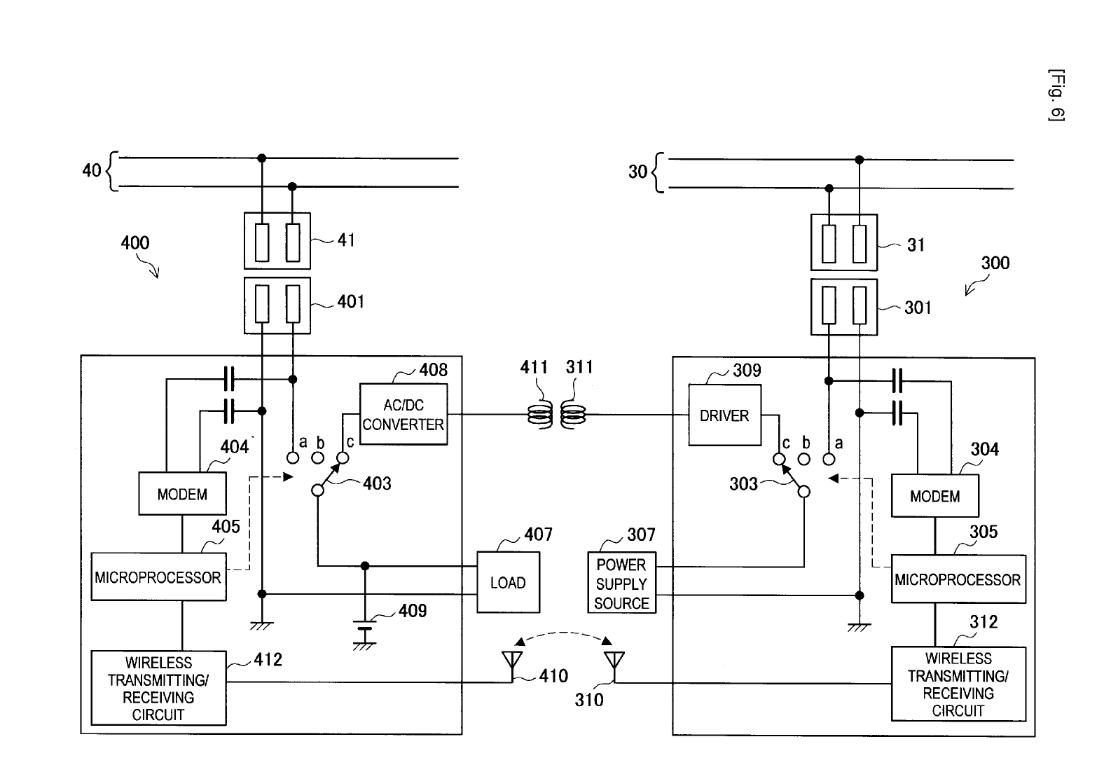

FIG. 6 is an explanatory view showing a power supply system 2 according to a second embodiment. Hereinafter, the constitution of the power supply system 2 according to the second embodiment will be described using FIG. 6.

As shown in FIG. 6, the power supply system 2 according to the second embodiment is configured to include a power supply server 300 and a client 400.

The power supply server 300 is configured to include a connector 301, connecting wires 302 and 306, a main switch 303, a modem 304, a microprocessor 305, a power supply source 307, a driver 309, an antenna 310, a coupling coil 311, and a wireless transmitting/receiving circuit 312.

The client 400 is configured to include a connector 401, connecting wires 402 and 406, a main switch 403, a modem 404, a microprocessor 405, a load 407, an AC/DC converter 408, a battery 409, an antenna 410, a coupling coil 411, and a wireless transmitting/receiving circuit 412.

First, the constitution of each component of the power supply server 300 will be described. The connector 301 is used for connecting a power supply server body and a bus line 30. The connecting wire 302 is used for connecting the connector 301 and the power supply server body. The main switch 303 controls electric power output. When the main switch 303 is located at an “a” position, electric power can be supplied to the bus line 30 through a wire. When the main switch 303 is located at a “c” position, electric power can be wirelessly supplied through a power coupler. When the main switch 303 is located at a “b” position, the wired and wireless electric power supply is stopped. As the main switch 303, a mechanical switch may be used.

The modem 304 is used for transmitting and receiving information between other power supply server and client through a wire. The wireless transmitting/receiving circuit 312 is used for wirelessly transmitting and receiving information between other power supply server and client through the antenna 310. The wireless transmitting/receiving circuit 312 transmits the communication signal to the antenna 310 and receives the communication signal wirelessly received by the antenna 310.

The microprocessor 305 is used for controlling the operation of the power supply server 300. For example, when negotiation between the power supply server 300 and the client 400 is completed, the microprocessor 305 sets the main switch 303 to the “c” position so that electric power is supplied from the power supply source 307, whereby electric power can be supplied to the client 400 through the coupling coils 311 and 411.

The connecting wire 306 is used for connecting the power supply server body and the power supply source 307. The power supply source 307 can supply electric power including AC voltage. When the main switch 403 of the power supply server 300 is set to the “a” position or the “c” position, electric power can be supplied through a wire or wirelessly.

The driver 309 drives electric power from the power supply source 307 with a frequency optimized for the coupling coil 311. The AC power with the frequency optimized for the coupling coil 311 is output to the coupling coil 311 by the driver 309.

The antenna 310 transmits and receives signals wirelessly. The antenna 310 receives signals wirelessly transmitted from other server (the synchronous server and the power supply server) and client and wirelessly transmits signals to other server and client. When the antenna 310 wirelessly receives signals from other server and client, the signal is transmitted to the wireless transmitting/receiving circuit 312 to be subjected to the demodulation processing in the wireless transmitting/receiving circuit 312. The signal subjected to the demodulation processing in the wireless transmitting/receiving circuit 312 is wirelessly transmitted from the antenna 310 to arrive at other server and client.

Hereinbefore, the constitution of each component of the power supply server 300 has been described. Next, the constitution of the client 400 will be described. The connector 401 connects client body and a bus line 40. The connecting wire 402 is used for connecting the connector 401 and the client body. The main switch 403 controls electric power input. When the main switch 403 is located at the “a” position, it becomes possible to receive the electric power supply from the bus line 40 through a wire, and if the main switch 403 is located at the “c” position, it becomes possible to wirelessly receive the electric power supply through a power coupler. When the main switch 403 is located at the “b” position, the wired or wireless electric power supply through a wire or wirelessly is stopped. As the main switch 403, a mechanical switch may be used.

The modem 404 is used for transmitting and receiving information between other power supply server and client. The wireless transmitting/receiving circuit 412 is used for wirelessly transmitting and receiving information between other power supply server and client through the antenna 410. The wireless transmitting/receiving circuit 412 transmits the communication signal to the antenna 410 and receives the communication signal wirelessly received by the antenna 410.

The microprocessor 405 controls the operation of the client 400. For example, when negotiation between the power supply server 300 and the client 400 is completed, the microprocessor 405 sets the main switch 403 to the “c” position so as to receive electric power supplied from the power supply server 300, whereby it becomes possible to receive electric power supplied from the power supply server 300 through the coupling coils 311 and 411.

The connecting wire 406 is used for connecting the client body and the load 407. The load 407 is a block consuming electric power supplied from the power supply server. The AC/DC converter 408 is a rectification circuit for use in converting AC current supplied from the power supply server 300 through the coupling coils 311 and 411 to DC current with different voltage. The battery 409 stores electric power supplied from the power supply server. Although not illustrated in FIG. 6, the client 400 may include a charge control circuit controlling charge and discharge of the battery 409.

The antenna 410 transmits and receives signals wirelessly. The antenna 410 receives signals wirelessly transmitted from other server (the synchronous server and the power supply server) and client wirelessly transmits signals to other server and client. When the antenna 410 wirelessly receives a signal from other server and client, the signal is transmitted to the wireless transmitting/receiving circuit 412 to be subjected to the demodulation processing in the wireless transmitting/receiving circuit 412. The signal subjected to the demodulation processing in the wireless transmitting/receiving circuit 412 is wirelessly transmitted from the antenna 410 to arrive at other server and client.

The coupling coil 411 is provided so as to pair with the coupling coil 311. The coupling coils 311 and 411 constitute the power coupler.

Hereinbefore, the constitution of the client 400 has been described. Next, the operation of the power supply server 300 and the client 400 having the above constitution shown in FIG. 6 will be described. In this example, the client 400 is already assigned an appropriate address and is in a state capable of receiving electric power from the power supply server 300.

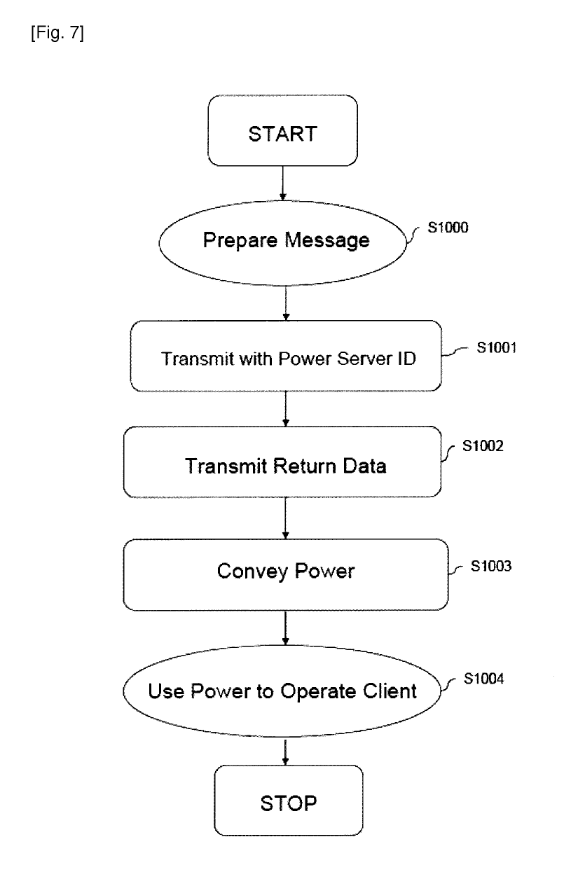

FIG. 7 is a flow chart showing the exchange of the power server ID, and return data prior to the power server conveying power to the client. The process begins in step S1000 where the server prepares a message and then transmits the message in step S1001 with the power server ID. The process then proceeds to step S1002 where the client transmits return data. This return data may indicate the requested power profile for the particular client device. The process then proceeds to step S1003 where the power server conveys the power to the client in the requested format. The process then proceeds to step S1004 where the client uses the power conveyed from the power server to operate the client.

### 2-2. Operation of Power Supply System

When the power supply server 300 starts operation, the power supply server 300 receives the synchronous packet through a wireless signal link (for example, the antenna 310) to register itself as the power supply server on the synchronous server existing on the bus line 20 side. Namely, the power supply server 300 transmits a registration packet for the synchronous server from the antenna 310, and the client 400 having received the registration packet from the power supply server 300 through the antenna 410 transmits the registration packet, received from the power supply server 300, to the synchronous server through the modem 404 and the microprocessor 405.

The power supply server 300 is assigned an address, and such information that the new power supply server 300 is connected to the bus line 20 is broadcasted from the synchronous server to the server and the client connected to the bus line 20. Although the information is notified to the power supply server 300 as well through the antenna 310, the power supply server 300 does not respond to the information. Consequently, the client 400 can know the addition of the new power supply server 300. Since the client 400 has not been received the supply of electric power, the client 400 starts negotiations with the registered power supply server 300.

When negotiation between the power supply server 300 and the client 400 is successfully performed, the power supply server 300 and the client 400 respectively set the main switches 303 and 403 on the c side so that electric power can be wirelessly supplied by the power coupler. Then, electric power is transmitted between the power supply server 300 and the client 400 through the coupling coils 311 and 411. Since the timing of transmitting and receiving electric power is controlled by the synchronous server (not shown) connected to the bus line 20, the power slot of the bus line 20 is allocated, and the time of the power slot is used.

Depending on the connection conditions between the coupling coils 311 and 411, the electric power having a similar specification to that obtained by the negotiation between the power supply server 300 and the client 400 is not obtained. Thus, the client 400 may check the contents of electric power received from the power supply server 300 (by means of the microprocessor 405, for example). As a result of the check, when electric power is adjusted, the client 400 negotiates with the power supply server 300 again, and if the power supply server 300 has a mechanism for adjusting electric power, the power specification may be changed on the power supply server 300 side so that electric power is optimal at a power receiving end. Of course, if the power supply server 300 does not have the mechanism for adjusting electric power, the client 400 receives some electric power and thereafter may abandon the reception of electric power from the power supply server 300. However, in the power supply server which can supply electric power wirelessly, in order to correspond to a variation of the power conditions due to a wireless link, adjustable electric power capability is preferably provided. When referring to supplying (or conveying) electric “power” wirelessly, this description covers the conveyance of energy from one device to another that is later used to provide operational power to the receiving device.

Hereinbefore, the operation of the power supply server 300 and the client 400 has been described. In the power supply server 300 and the client 400 having the constitution shown in FIG. 6, the switching of the main switches 303 and 403 allows transmission and reception of electric power through a wire, and the power supply server 300 and the client 400 can be connected as they are to an existing power supply system.

In the second embodiment, the time slot used by the power link is under the complete control of the power supply system around the bus line 20. However, the power link by the coupling coils 311 and 411 can operate completely independently from the power supply system around the bus line 20. Thus, in a pair of server and client having a wireless power link, there can be realized such a usage that, after agreements are obtained by negotiation between the server and the client, connection by a power coupler of the power link is maintained.

In order to correspond to the above usage, in the present embodiment, parameters being “wireless power link” and “the number of connectable links” are provided in a profile of the server and the client. Then, the conditions of negotiation between a pair of the server and the client having the wireless power link are extended to include conditions such as “always-on connection” and “connection and disconnection by the agreements between the server and the client”. The “always-on connection” in this case is performed just under the control of the microprocessors 305 and 405, and electric power lines are not permanently connected. Namely, the “always-on connection” means that although the power link can be cut at any time as intended by the micro-processors 305 and 405, the usage is continued for a time.

In the second embodiment, a pair of the wireless power links is provided, and there is a one-to-one wireless power link. However, in the power link using a magnetic field, if the efficiency is somewhat compromised, one-to-many and many-to-many links can be constituted. When the wireless power link is one-to-many (the power transmitting side: 1 and the power receiving side: many), the time slot is provided, and electric power can be transmitted time-divisionally or simultaneously to a plurality of clients. When electric power is transmitted time-divisionally, by virtue of the use of a protocol executing the operation as describe above, the power specification agreed between the server and the client can be used. Meanwhile, in the simultaneous power transmission to a plurality of clients, although optimization for each client may not be impossible to be performed, it is possible to use such a power specification usable by all clients. Further, it is possible to prevent the client that is not matching the power specification from receiving electric power on the client side.

### 3. Conclusion

According to each embodiment as described above, it is possible to constitute a server, a client, and a power supply system including the server and the client, in which communication is performed separately from electric power transfer and the communication is performed wirelessly. Further, electric power can be transferred not only through a wire, but also wirelessly.

It should be understood by those skilled in the art that various modifications, combinations, sub-combinations and alterations may occur depending on design requirements and other factors insofar as they are within the scope of the appended claims or the equivalents thereof.

The present application contains subject matter related to that disclosed in Japanese Priority Patent Application JP 2009-244424 filed in the Japan Patent Office on Oct. 23, 2009, the entire content of which is hereby incorporated by reference.

The present invention can be applicable to a power supply device, a power receiving device, a power supply system, and a power supply method.

### ELEMENT NUMBER LISTING

1,2 power supply system

100 power supply server

101 connector

102 connecting wire

103 main switch

104 modem

105 microprocessor

106 connecting wire

107 power supply source

109 fuse

110 antenna

111 sub switch

112 resistor

113 sub voltage supply

200 client

300 power supply server

301 connector

302,306 connecting wire

303 main switch

304 modem

305 microprocessor

307 power supply source

309 driver

310 antenna

311 coupling coil

312 wireless transmitting/receiving circuit

400 client

401 connector

402,406 connecting wire

403 main switch

404 modem

405 microprocessor

407 load

408 AC/DC converter

409 battery

410 antenna

411 coupling coil

412 wireless transmitting/receiving circuit

1. A power server comprising:
a processor that prepares message content including an identification of the power server;
an electrical interface that is configured to transmit the message content with the identification to a client and receive return data from the client, and
convey energy via a medium to the client for providing operational power to the client.

2. The power server of claim 1, wherein:
said electrical interface includes an antenna through which the message content is transmitted and the return data is received; and
said medium includes an electrical conductor.

3. The power server of claim 1, wherein:
said electrical interface transmits the message content wirelessly, and
said medium including an air space through which the energy is conveyed to the client.

4. The power server of claim 1, wherein said processor is a software programmable processor.

5. The power server of claim 1, wherein said processor is a logic-based processor.

6. The power server of claim 1, wherein said electrical interface is controllable to select between a wired medium for conveying said energy via a conductor to said client, and a wireless medium for conveying said energy to said client wirelessly.

7. The power server of claim 1, wherein said identification is a unique identification that distinguishes said power server from another power server.

8. The power server of claim 1, wherein said processor is configured to adjust a specification of said energy conveyed to said client based on the return data received from said client.

9. A client device comprising:
an electrical interface that is configured to receive message content including an identification of a power server; and
a processor that prepares return data that is transmitted via said electrical interface to said power server, wherein
said electrical interface is configured to accept energy via a medium from the power server for providing operating power to the client device.

10. The client device of claim 9, wherein:
said electrical interface includes an antenna through which the return data is transmitted and the message content is received; and
said medium includes an electrical conductor.

11. The client device of claim 9, wherein:
said electrical interface receives the message content in a wireless transmission, and said medium including an air space through which the energy is conveyed via the power server.

12. The client device of claim 9, wherein said processor is a software programmable processor.

13. The client device of claim 9, wherein said processor is a logic-based processor.

14. The client device of claim 9, wherein said electrical interface is controllable to select between a wired medium for accepting said energy via a conductor from said power server, and a wireless medium for accepting said energy wirelessly from said power server.

15. The client device of claim 9, wherein said identification is a unique identification that distinguishes said power server from another power server.

16. The client device of claim 9, wherein said processor is configured to indicate a specification of said energy to be conveyed from said power server as indicated in the return data transmitted from said client device.

17. A computer implemented method for conveying energy to a client device comprising:
preparing message content including an identification of a power server at the power server;
transmitting the message content with the identification to the client device;
transmitting return data from the client to the power server;
conveying energy from the power server via a medium to the client; and
using said energy conveyed in said conveying step to provide operational power for powering the client.

18. The method of claim 17, wherein:
said transmitting the message content includes wirelessly transmitting the message content; and
said conveying said energy includes conveying said energy on an electrical conductor.

19. The method of claim 17, wherein:
said transmitting the message content includes wirelessly transmitting the message content; and
said conveying said energy includes conveying said energy wirelessly.

20. The method of claim 17, further comprising:
specifying in said return data a power specification for the energy to be conveyed in said conveying step, said power specification indentifying at least one parameter that is compatible with power requirements of said client device.
